(19) United States
(12) Patent Application Publication
(10) Pub. No.: US 2015/0378938 A1
(43) Pub. Date: Dec. 31, 2015

(54) WEARABLE COMPUTER WITH EXPANDABLE LINK CAPABILITIES

(71) Applicant: Nate L. Lyman, Livermore, CA (US)

(72) Inventor: Nate L. Lyman, Livermore, CA (US)

(21) Appl. No.: 14/320,514

(22) Filed: Jun. 30, 2014

(51) Int. Cl. G06F 13/10; G06F 11/30; G06F 11/22; G06F 13/22

(52) U.S. Cl. CPC G06F 13/102; G06F 13/22; G06F 11/3051; G06F 11/2289

(57) ABSTRACT

A wearable computer system comprising one or more processors, memory, and an attachment accessory is disclosed. The wearable computer system that includes one or more removable link components, the attachment accessory operatively to secure the system to the person of a user, the wearable computer system being configured such that the removable link components can be added to or removed from the attachment band and the capabilities of the wearable computer system change as components are added or removed.

### TECHNICAL FIELD

This application relates generally to the field of electronic devices and, in a specific example implementation, to wearable computers (e.g., a computerized wristwatch, computerized glasses, health monitoring devices etc.).

### BACKGROUND

The rise in electronic and digital device technology has rapidly changed the way society interacts with media and consumes goods and services. Digital technology enables a variety of consumer devices to be available that are very flexible and relatively cheap. Specifically, modern electronic devices, such as smart phones and tablets, allow a user to have access to a variety of useful applications even when away from a traditional computer.

### BRIEF DESCRIPTION OF THE DRAWINGS

The present description is illustrated by way of example, and not by way of limitation, in the figures of the accompanying drawings, in which:

FIG. 1 is a diagram depicting a computerized watch system with extendable links, in accordance with some embodiments.

FIG. 2 is a block diagram illustrating a central component 102, in accordance with some embodiments.

FIG. 3 is a block diagram of an example data structure for a list of link components currently in a wristband, in accordance with some implementations.

FIG. 4 is a flow diagram illustrating a process for enabling a computerized watch system to dynamically add or remove link components, in accordance with some implementations.

FIG. 5A is a user interface diagram showing an example user interface for a computerized watch system with a display, in accordance with some embodiments.

FIG. 5B is a user interface diagram showing an example user interface for a computerized watch system with a display, in accordance with some embodiments.

FIG. 5C is a user interface diagram showing an example user interface for a computerized watch system with a display, in accordance with some embodiments.

FIG. 5D is a user interface diagram showing an example user interface for a computerized watch system with a display, in accordance with some embodiments.

FIG. 6 is a flow diagram illustrating a process for enabling removable link components in a computerized watch system, in accordance with some implementations.

FIG. 7 is a flow diagram illustrating a process for enabling removable link components in a computerized watch system, in accordance with some implementations.

FIG. 8 is a block diagram illustrating an architecture of software 800, which may be installed on any one or more of devices of FIG. 1 (e.g., client device(s) 110).

FIG. 9 is a block diagram illustrating components of a machine, according to some example embodiments.

Like reference numerals refer to corresponding parts throughout the drawings.

### DETAILED DESCRIPTION

Although the implementations have been described with reference to specific example implementations, it will be evident that various modifications and changes may be made to these implementations without departing from the broader spirit and scope of the description. Accordingly, the specification and drawings are to be regarded in an illustrative rather than a restrictive sense.

In various implementations, methods and systems for enabling a wearable computer (e.g., a smart watch or a computerized watch, wearable health monitoring device, wearable activity monitoring device or smart glasses) with extendable link capabilities are described. While the example embodiments are discussed with reference to a computerized watch system, other embodiments may be implemented with respect to any wearable computer devices, such as computerized glasses (e.g., glasses with an embedded computer system), computerized activity monitoring devices (e.g., an armband with a computer system, a belt with a computer system, a necklace with an embedded computer system, or shoes with embedded computer systems), and computerized health monitoring devices.

Taking the computerized watch system as an example of a wearable computer (e.g., a smart watch), a system is an electronic watch that has capabilities above the traditional watch functionalities. For example, a traditional watch includes one or more time based capabilities such as displaying the current time, running a timer, setting an alarm, and other similar and related capabilities.

In contrast, a computerized watch includes a variety of other capabilities. For example, a smart watch may include a touch screen as an input device. Using the touch screen, a user is able to input commands into the smart watch and to receive output from a variety of applications. Thus, in addition to the basic time applications used by a non-smart (or traditional) watch, a smart watch may run internet browser applications, search applications, media presentation applications, communication applications, productivity applications, game applications, word processing applications, or any other useful applications.

However, wearable computers, like many other wearable and personal electronic devices (smart phones, tablets, etc.) are constructed to be as small as possible. Indeed, wearable computer devices have even greater size constraints than other electronic devices because they are made to be worn by the user in a way that is as convenient and non-intrusive as possible. As such, space is very limited and components are made specifically to fit together with as small a footprint as possible. This results in many wearable devices that have parts that cannot easily be replaced to upgrade the capabilities of the device or devices that have a very narrow number of options to upgrade. However, this problem is addressed by a wearable device that includes one or more extendable components (e.g., replaceable smart links in the wrist band of a computerized watch).

The wearable device system, according to one example embodiment, includes a central component (e.g., the watch face) that is connected to one or more links that form an attachment accessory (e.g., a band of the watch), that enable of the essential component to be secured to the body of a person. The central component contains one or more microprocessors and memory. The memory stores programs that, when executed by the one or more processors, can perform any number of methods. Each link component connects to the face of the watch through a communication link.

In some example implementations, each replaceable component (e.g., a link component) of the attachment accessory includes electronic hardware and instructions to perform one or more capabilities. The central component is communicatively coupled to each link component of the attachment accessory through a communication method (e.g., a hardwired communication channel or bus, or a wireless communication channel) and can access the capabilities of each respective link. Furthermore, the central component and/or attachment accessory are configured such that new links can be added to the attachment accessory. As such, a user can change the capabilities of the wearable device system by changing the components that are attached to its attachment accessory. In this way, a user can customize the capabilities that the wearable device system has. Indeed, the wearable device user can change the capabilities of their wearable device system frequently to fit a specific need or use. For example, if a user wants to record statistics for a run, the user can swap in a link that counts steps or measures heart rate, and then remove it when the run is finished. In this way, the wearable device system with extendable components is much more flexible than other, non-extendable electronic devices.

In some example embodiments the central component communicates with each removable component through a communication connection system that enables the central component to communicate with all the removable components that are current attached to the central component. In some example embodiments the central component communicates directly with each removable component (e.g., the system is set up such that each component has a dedicated communication path). In other embodiments each removable component is able to pass along communications such that each component communicates with the central component by communicating with the component directly next to it and that communication is passed on until it reaches the central component. In some example embodiments power can also be passed from the central component to the removable components and also from one or more of the removable components to the central component (e.g., if one of the removable components has additional battery capacity.

In some example embodiments the central component enters a “pairing mode” when further components are added to the wearable device. When in a “pairing mode” the central component is put in a state in which it can be paired with additional link components. In some example embodiments the user interface prompts the user to affirmatively accept an additional link component is being paired with the central component.

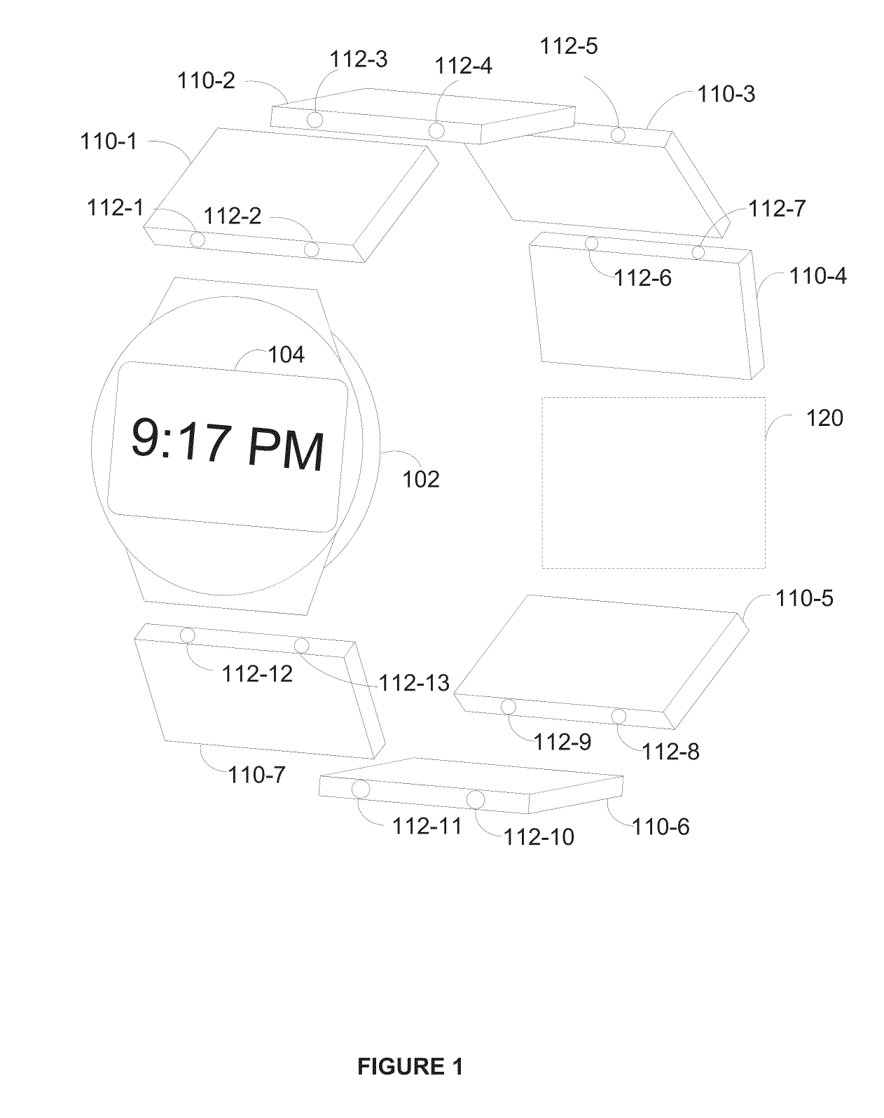

In the case of a wearable device system, there are a variety of component types that can be attached to a central component (e.g., component 102 as seen in FIG. 1), including, but not limited to, an additional memory capacity component, an additional battery capacity component, an additional processing capacity component, a step counter, a fitness tracker, a GPS tracker, a compass component, a blood glucose monitor, a camera component, a voice recording component, an RFID tag component, a BLUETOOTH component, a proximity sensor component, an infrared sensor, a remote control component, an environment measuring component, or a wireless communication component.

In some implementations, the central component (e.g., component 102 as seen in FIG. 1) itself can be replaced such that the wristband (e.g., a band for a watch or watch band) is unchanged but central component is replaced with an upgraded component.

In addition, each removable component can be produced independently from the wearable computer system. To accomplish this, a standard communication interface and one or more standard form factors would be developed such that any party can produce a component for the wearable device. Such components would need to be configured to be physically included in a securing attachment to secure the wearable computing device to the body of a person, and including a communication interface to communicate with the wearable computing device.

FIG. 1 is a diagram depicting a wearable computer in the example form of a smart watch system (also referred to as a computerized watch) with extendable links, in accordance with some implementations. The smart watch system with extendable links includes a central component (e.g., including a display interface of the smart watch system) 102, one or more link components 110-1 to 110-7, and space for additional extendable watch links 120.

The central component 102, is an electronic device that includes one or more microprocessors, at least one computer readable storage medium, and instructions stored on the at least one computer readable storage medium. The central component 102 also includes a display 104. In some implementations, the display 104 is also a touch screen that allows users to input commands to the central component 102 through a series of predefined touches and gestures. In other implementations, the display 104 is not a touch screen, and input is received from the user through other input means (e.g., buttons on the central component 102 or one of the extendable links or an external remote control of some kind.)

The central component 102 performs basic time keeping functions, including, but not limited to, recording, tracking, and displaying the current time. In some implementations, the central component 102 uses digital circuitry to monitor and display the current time with a high degree of precision. Any method for tracking and displaying time accurately may be used. In some implementations, the central component 102 also provides timer (e.g., stop watch) functionality and/or time based alert functionality (e.g., alerts the user when a predetermined amount of time has passed.)

The central component 102 also includes link communication applications. The link communication applications use ports (not pictured) on the central component 102 and corresponding connection ports 112-1 to 112-13 on each link component 110-1 to 110-7 that enable data to be passed between the central component 102 and each of the link components 110-1 to 110-7. Any acceptable technology can be used to form the communication links between the central component 102 and the various other components. In a further example embodiment, communications between a link and in the central component 102 may be performed wirelessly (e.g., using BLUETOOTH Low Energy (BLE), ANT/ANT+ or low-power Wi-Fi). In this case, a particular link may communicate directly with the central component 102, as well as with other links included within attachment accessory.

In some implementations, the communication links work such that data can originate with the central component 102 and have an associated target link component 110. Then the data is passed along from one link component 110 to the next link component 110 in the wristband until the target link component 110 is reached.

In some implementations, the central component 102 periodically determines whether any link components 110 have been added or removed. For example, the central component 102 sends a request to all components that instructs each component to identify itself to the central component 102. The central component 102 then matches the received identifications with an internal list of the currently attached link components 110.

If the central component 102 determines that the group of attached link components 110 has changed, the central component 102 then determines what link component(s) 110 have changed. The central component 102 determines if a component has been removed by comparing the current list of attached components against the list of components that responded to its identification request message. Any link component 110 that is on the current list of attached components but does not respond is determined to have been removed. The central component 102 then removes the removed link component 110 from the list of currently attached components.

If the central component 102 receives a component identification response message from a component link that is not included in the list of current components, the central component 102 determines that the link component 110 has been added to the smart wristband. Once a new link component 110 has been detected, the central component 102 determines the capabilities of the newly added link component 110. In some implementations, the central component 102 receives a component identification code from the newly added link component 110 in the component identification response message. The central component 102 then uses the component identification code to identify the capabilities of the component, either based on data already stored at the central component 102 (e.g., an internal table of all possible components) or using an external source to determine the capabilities associated with the component identification code (e.g., by contacting a third party server over a communication network). The central component 102 then stores the determined capabilities in a list of current capabilities.

In other implementations, a new link component 110 sends a description of its capabilities to the central component 102 in response to the component identification request message. The central component 102 then adds the new link component 110 to the list of current components and stores the newly added capabilities in the list of current capabilities.

In some implementations, link components 110 automatically notify the central component 102 when they are added to or removed from the watch link chain. In this way, the central component 102 doesn't have to periodically poll the components to determine if another link has been added or a link has been removed from the watch link chain. When the central component 102 receives an automatic notification from a component, the central component 102 then updates both the list of current components and the list of current capabilities.

Each extendable component link 110-1 to 110-7 includes one or more connection ports 112-1 to 112-13 that allow it to connect with the rest of the link band and the central component 102, as well as to send and receive data from the other watch components.

The watch system also includes space 120 to add additional components.

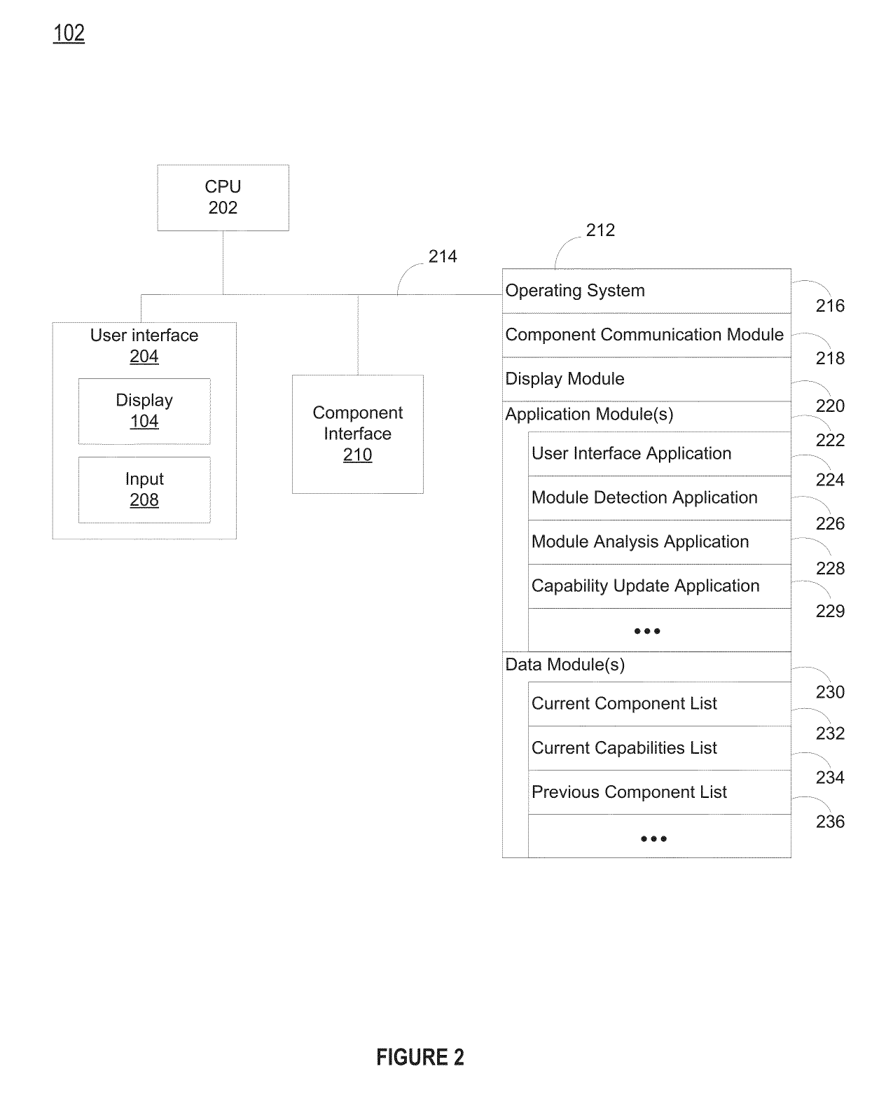

FIG. 2 is a block diagram illustrating a central component 102, in accordance with some embodiments. Although a central component is depicted, the central component of an extendable wearable device would include analogous components. The central component 102 typically includes one or more processing units (CPUs) 202, one or more component interfaces 210, memory 212, and one or more communication buses 214 for interconnecting these components. The central component 102 includes a user interface 204. The user interface 204 includes a display 104 and optionally includes an input 208, such as buttons or any other suitable input 208. In some implementations, the display is a touchscreen device and the user is able to input commands via the touchscreen. Furthermore, some watch systems use a microphone and voice recognition to supplement or replace other input devices.

Memory 212 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 212 may optionally include one or more storage devices located remotely from the CPU(s) 202. Memory 212, or alternately the non-volatile memory device(s) within memory 212, comprises a non-transitory computer readable storage medium.

In some embodiments, memory 212 or the computer readable storage medium of memory 212 stores the following programs, modules and data structures, or a subset thereof:
an operating system 216 that includes procedures for handling various basic system services and for performing hardware dependent tasks;
a component communication module 218 that is used for connecting to and communicating with the various link components currently in the wristband based on a current component list 232;
a display module 220 for enabling the information generated by the operating system 216 and application modules 222 to be presented visually on the display 104;
one or more application modules 222 for performing various functions associated with the central component 102, including but not limited to:
   a user interface application 224 for displaying a user interface on the display 206 of the central component 102 including the current time, icons associated with one or more capabilities of the central component 102, and application specific interfaces based on what application the user is currently interacting with;
   a module detection application 226 for detecting when a link component is added to the wristband or a link is removed from the wristband by either periodically polling the wristband components for a list of current link components or receiving link component update messages from components as they are added to or removed from the wristband;
   a module analysis application 228 for determining the capabilities of link components currently included in the wristband, the determining based on receiving a component identification code from each link component or receiving capabilities data from each link component; and
   a capability update application 229 for updating the current component list 232, a current capabilities list 234, and a previous component list 236 as components are added to and removed from the wristband; and
a data module 230 for storing data relevant to the smart watch system, including but not limited to:
   a current component list 232 that includes a list of each link component that is currently included in the wristband;
   a current capabilities list 234 that includes a list of all the capabilities currently available to the central component 102 based on the capabilities integrated into the central component 102 and the capabilities of the current link components; and
   a previous component list 236 that includes a list of link components that were previously (but are no longer) connected to the central component 102 as part of the current wristband.

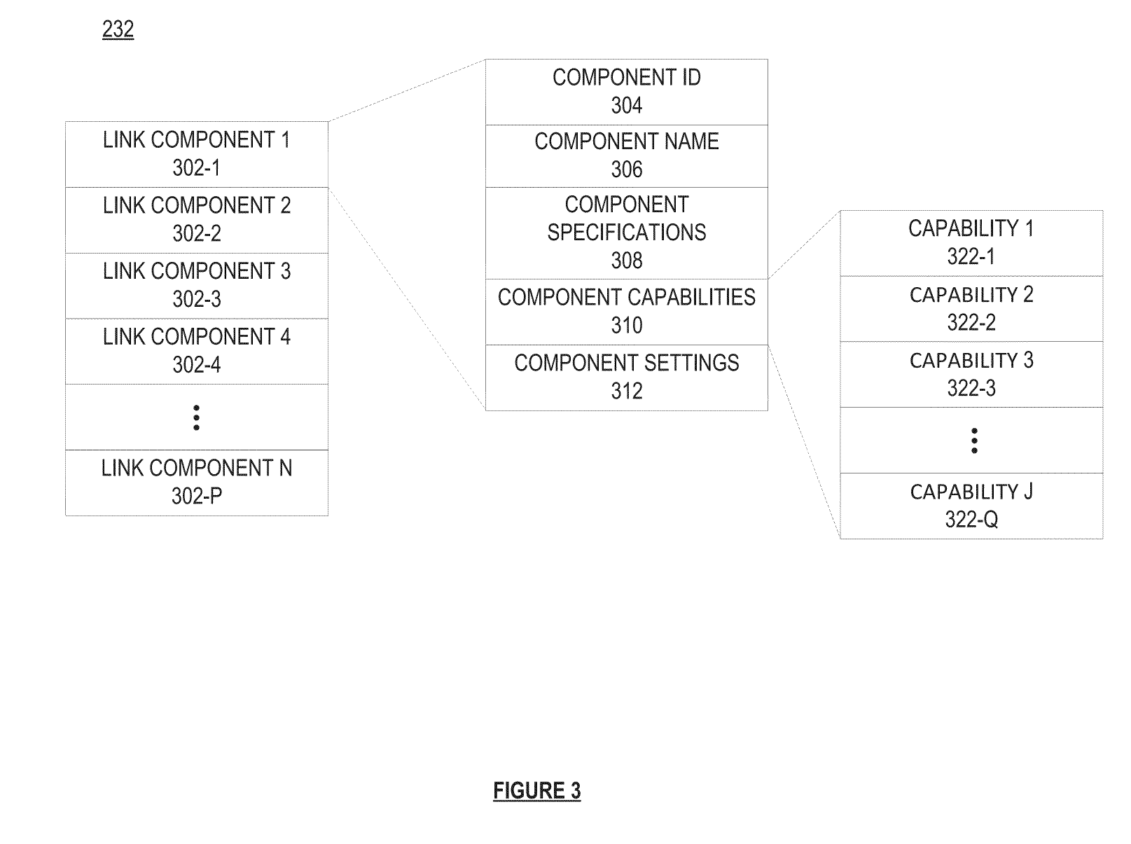

FIG. 3 depicts a block diagram of an example data structure for a current component list 232, in accordance with some implementations. The current component list 232 includes multiple link component records 302-1 to 302-P, each of which corresponds to a removable link component that currently is connected to the central component (e.g., central component 102 of FIG. 1) as part of a wristband. The link components included in the current component list 232 are updated as link components are added to or removed from the wristband. For example, link component 3 (e.g., a link component that enables GPS navigation) is removed from the wristband as the user arrives at work and adds a new link component 5 (e.g., a link that contains additional battery capacity). The current component list 232 is updated to reflect these changes. Each link component record 302-1 to 302-P stores the relevant information for the corresponding link component.

In some implementations, a link component record 302 stores a unique component ID 304 for the link component, a component name 306, component specifications 308 of the link component, a list of one or more component capabilities 310, and component settings 312.

In some implementations, the component name 306 is a text name of the link component and is used to identify the component to the user of the smart watch system. For example, the component name 306 includes a branded identifier or a commonly used name for a component, rather than a technical description of the link component. The component specifications 308 include any specifications needed to effectively use the capabilities provided by the link component. For example, the component specifications include the power needed by the component, the various services provided by the link component and the method for accessing them (e.g., an API), and other important information.

The list of one or more component capabilities 310 includes one or more capability records 322-1 to 322-Q (e.g., functions or services provided by the link) that are provided by the link component. For example, a link component provides GPS positions and the list of component capabilities 310 includes GPS positioning as one of the capabilities provided. In another example, the link component provides additional purchasing power and extra memory, and the list of component capabilities 310 includes both of the capabilities. The list of component capabilities 310 includes one or more capability records 322-1 to 322-Q. Each capability record includes the name of the capability and a description of what service or function it provides.

In some implementations, a link component record 302 includes component settings 312 for the link component. In some implementations, the component settings 312 include settings and preferences for the user. For example, if a link has wireless connection capacities, the component settings 312 include preferred wireless protocol, Wi-Fi networks and the accompanied user names and passwords. Similarly, a GPS component record includes past GPS locations or common routes associated with the user.

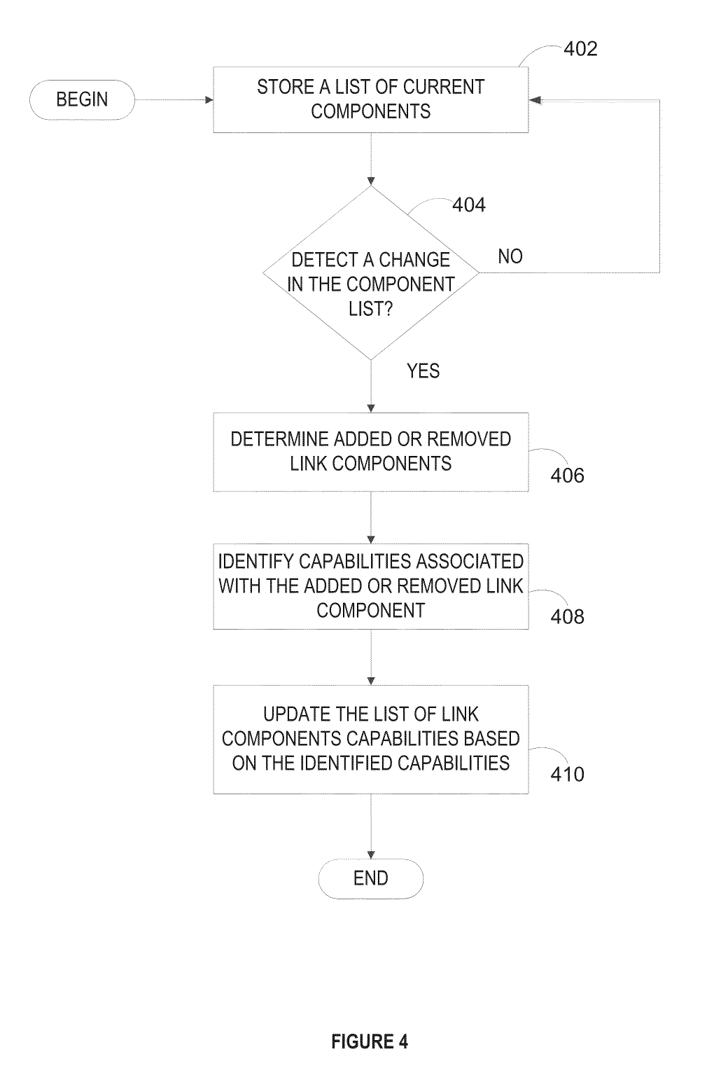

FIG. 4 is a flow diagram illustrating a process for enabling a smart watch system to dynamically add or remove link components, in accordance with some implementations. Each of the operations shown in FIG. 4 may correspond to instructions stored in a computer memory or computer readable storage medium. In some implementations, the method described with reference to FIG. 4 is performed by the central component (e.g., central component 102 as seen in FIG. 1).

The method is performed at a smart watch system including one or more processors and memory storing one or more programs for execution by the one or more processors. The central component (e.g., central component 102 as seen in FIG. 1) stores (402) a list of one or more current link components. Each link component in the list of one or more current components is currently connected to the central component (e.g., central component 102 as seen in FIG. 1) as part of a customizable wristband. The list is created by the central component (e.g., central component 102 as seen in FIG. 1) as components are added to the wristband or by detecting the link components already connected when the power is turned on.

The central component (e.g., central component 102 as seen in FIG. 1) then detects (404) whether a change in the list of current components has occurred. In some implementations, this detection is accomplished by periodically sending out a link identification request message (e.g., a message that requests each connected link to identify itself). The central component (e.g., component 102 as seen in FIG. 1) then records each response message and compares them against the current list of attached link components. If an expected component fails to respond, the central component (e.g., component 102 as seen in FIG. 1) determines that the link component has been removed. Similarly, if a link component that is not included in the current list of attached link components responds, the central component (e.g., component 102 as seen in FIG. 1) determines that a new link has been added.

In other implementations, the components themselves send a message to the central component (e.g., component 102 as seen in FIG. 1) when they are added or removed; thus, the central component (e.g., component 102 as seen in FIG. 1) does not have to periodically poll the attached components.

If a change is not detected, the central component (e.g., component 102 as seen in FIG. 1) continues to wait for possible link component changes. If there has been a change in the component link list, the central component (e.g., component 102 as seen in FIG. 1) determines which components have been added or removed (406). Once the links that have been added or removed have been determined, the central component (e.g., component 102 as seen in FIG. 1) then identifies (408) the capabilities associated with the component links that have been added or removed. For example, for a link that has been removed, the central component (e.g., component 102 as seen in FIG. 1) uses the link component record (e.g., link component record 302 in FIG. 3) to determine the capabilities associated with the removed link component.

The central component (e.g., component 102 as seen in FIG. 1) then updates (410) a list of current link component capabilities based on the identified capabilities. For example, a link component is added and the central component (e.g., component 102 as seen in FIG. 1) determines that the added link component is a step counter. The central component (e.g., component 102 as seen in FIG. 1) identifies that the step counter has two capabilities: it detects each step and keeps a running total of a user's steps. The central component (e.g., component 102 as seen in FIG. 1) then updates the list of capabilities to include the two new capabilities.

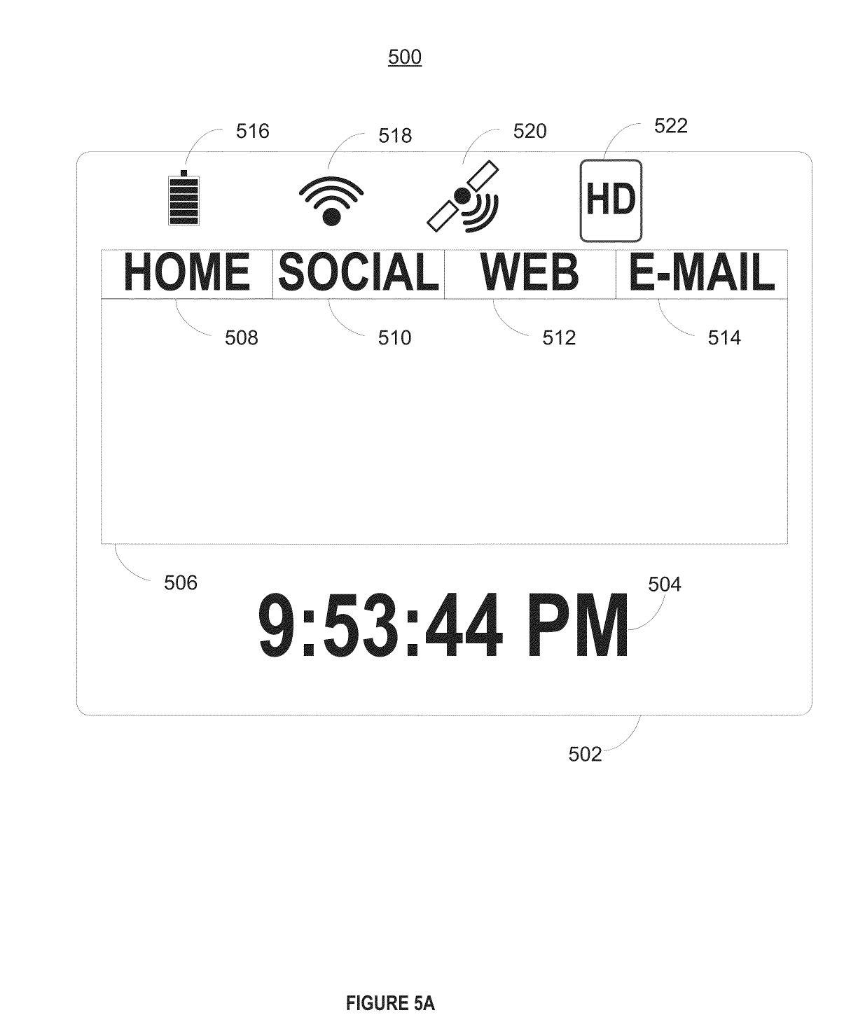

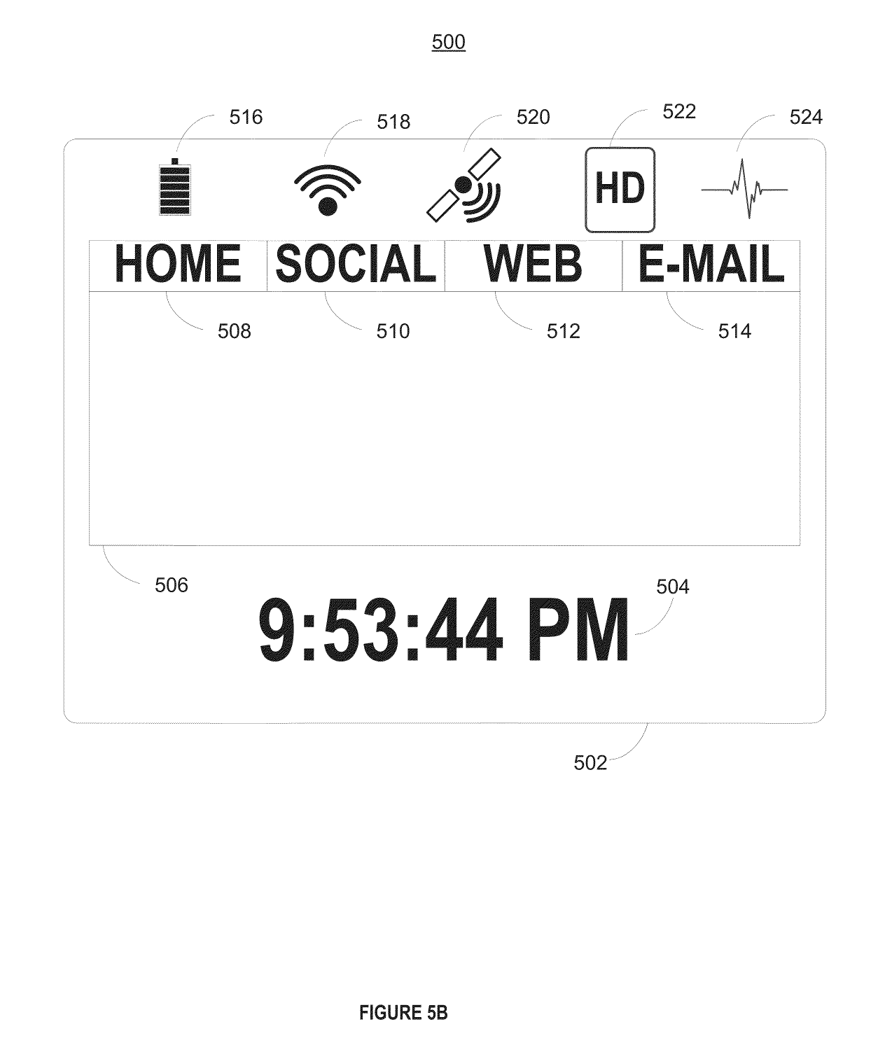

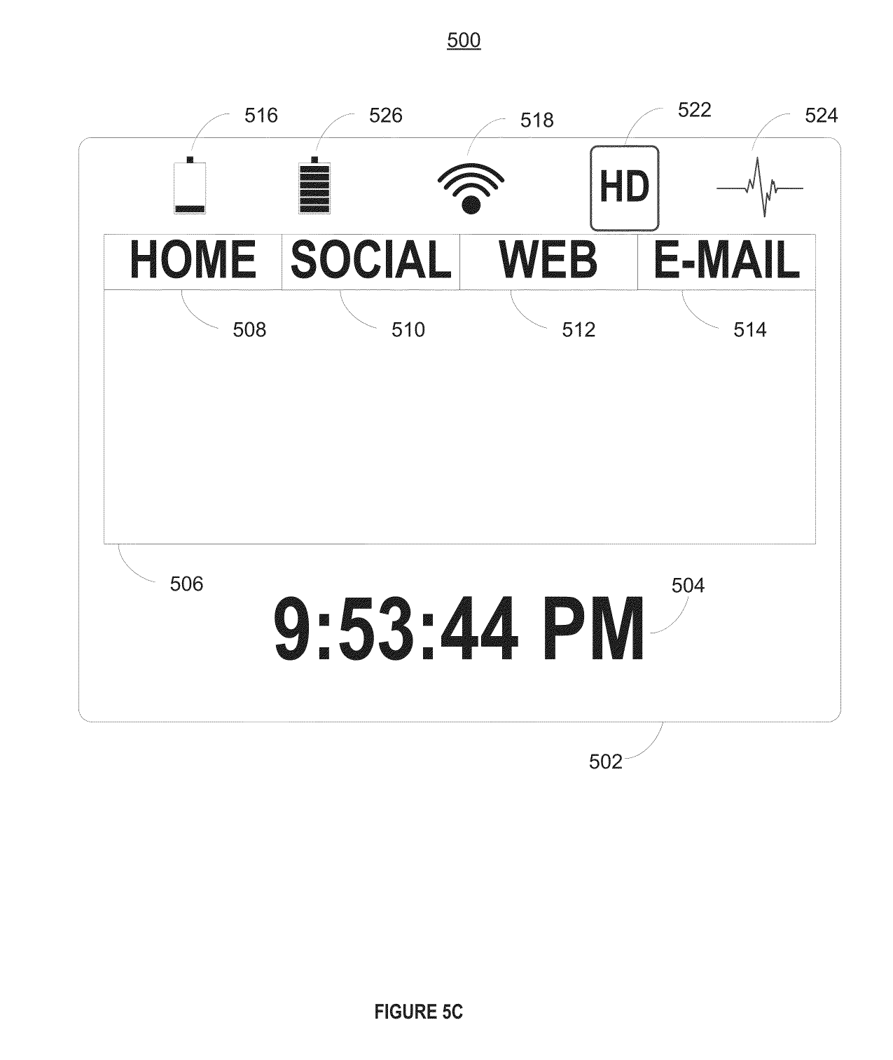

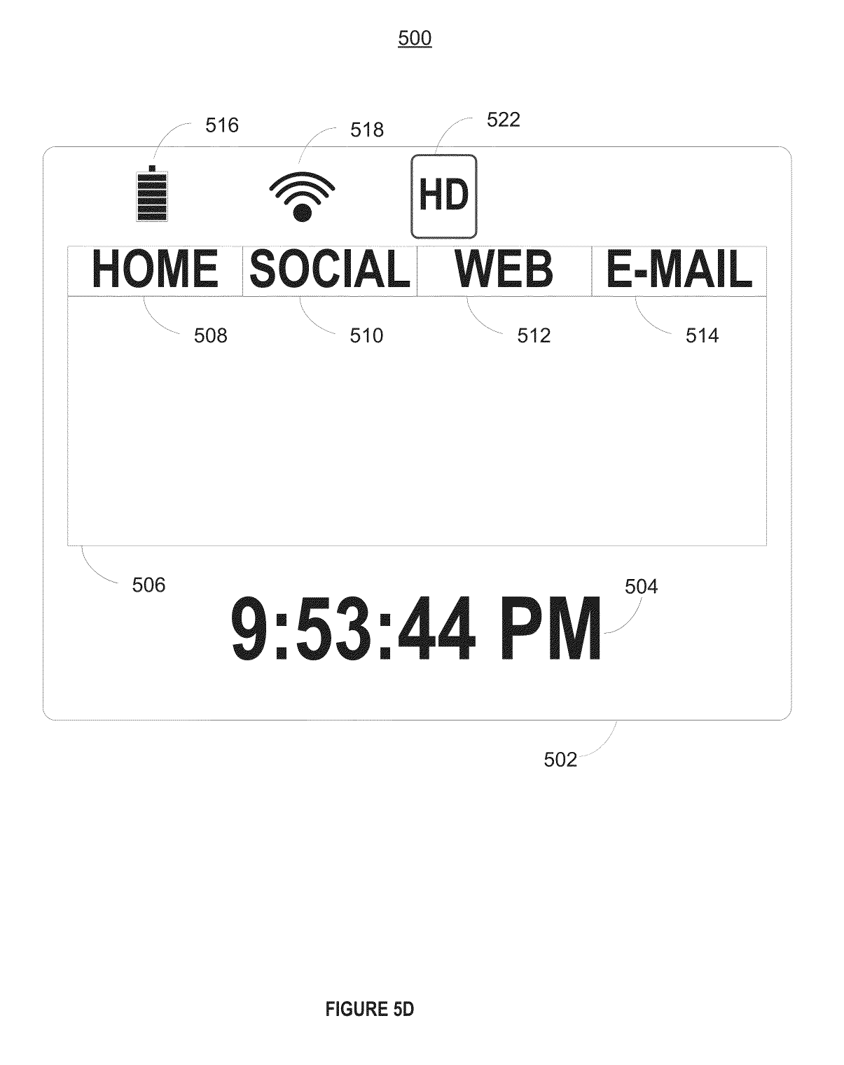

FIG. 5A illustrates an example user interface 500 for a smart watch system with a display, in accordance with some embodiments. In this example, the user interface 500 is displayed on a screen 502. In the lower portion of the screen the smart watch system displays the current time 504 (e.g., 9:53 pm).

The user interface 500 also includes a section of the screen 502 that acts as a display 506 for displaying additional information to a user. The display 506 also includes one or more tabs or buttons 508, 510, 512, and 514 for navigating through a user interface. For example, if the user selects the “Home” button 508, the display 506 will take a user back to a generic starting screen that may include a variety of app icons or menus for accessing applications on the smart watch system. In another example, when the user selects the “Social” tab 510 the display 506 links to one or more social services (e.g., Twitter, Facebook, chat programs, etc.). In other examples, the “web” tab 512 causes a web browser to be displayed in the display 506 and the “E-mail” button 514 causes an e-mail program to be displayed.

In some implementations, the user interface also displays symbols that represent at least some of the current capabilities of the link components currently connected to the central component (e.g., component 102 as seen in FIG. 1) as part of the wristband. For example, a battery icon 516 represents that the smart watch system has extended battery capacity. In another example, the display 506 includes a Wi-Fi symbol 518, a GPS symbol 520, and an extended storage symbol 522. These images (or symbols or icons) are updated as variation link components are added to or removed from the wristband associated with the smart watch system. In some example embodiments the symbols can represent a state of the components (e.g., the remaining battery capacity of a battery component).

FIG. 5B illustrates an example user interface 500 for a smart watch system with a display in accordance with some embodiments. As also seen above in FIG. 5A, the user interface 500 is displayed on a screen 502. In the lower portion of the screen the smart watch system displays the current time 504 (e.g., 9:53 pm).

Also, similarly to FIG. 5A, this example user interface has a section of the screen 502 that acts as a display 506, one or more tabs or buttons 508, 510, 512, and 514, and one or more icons or symbols 516, 518, 520, 522, and 524 showing the current capabilities of the smart watch system.

Continuing from the example in FIG. SA, the user interface 500 in FIG. 5B shows an additional icon, a heartbeat monitor symbol 524, which has been added to the group of icons. This change in the user interface 500 occurs when a new link component is added to the smart wristband. The smart watch system determines what capabilities the new link component provides and, if possible, adds a visual indication (e.g., a symbol or icon) representing the newly added capabilities so that the newly added capabilities are easy for the user to see.

FIG. 5C illustrates an example user interface 500 for a smart watch system with a display in accordance with some embodiments. As also seen above in FIG. 5A, the user interface 500 is displayed on a screen 502. In the lower portion of the screen the smart watch system displays the current time 504 (e.g., 9:53 pm).

Also, similarly to FIG. SA, this example user interface has a section of the screen 502 that acts as a display 506, one or more tabs or buttons 508, 510, 512, and 514, and one or more icons or symbols 516, 518, 526, 522, and 524 showing the current capabilities of the smart watch system.

Continuing from the example in FIG. 5A, the user interface has been updated to remove one icon (e.g., the GPS symbol 520 in FIG. 5A) and to add another (e.g., additional battery capacity icon 526). This change occurs in response to removing a first link component (e.g., the GPS positioning link component in FIG. 5A) from the smart wristband and adding a second link component (e.g., a link component with additional battery capacity). The smart watch system detects these changes and updates the displayed icons to match the current capabilities of the various link components. For example, a user wears a GPS link component as part of his or her smart watch system on the way into work to get directions andior track the user's mute. Once the user arrives at work, the user no longer needs the GPS link component functionality and thus switches the link out for a link component offering extra battery capacity to ensure that the smart watch system will not run out of power during the work day. The icons on the watch face are updated to reflect this change.

FIG. 5D illustrates an example user interface 500 for a smart watch system with a display, in accordance with some embodiments. As also seen above in FIG. 5A, the user interface 500 is displayed on a screen 502. In the lower portion of the screen the smart watch system displays the current time 504 (e.g., 9:53 pm).

Also, similarly to FIG. 5A, this example user interface has a section of the screen 502 that acts as a display 506, one or more tabs or buttons 508, 510, 512, and 514, and one or more icons or symbols 516, 518, and 522 showing the current capabilities of the smart watch system.

Continuing from the example in FIG. 5C, the user interface has been updated to remove two icons (e.g., the original battery capacity icon 516 and the heartbeat monitor symbol 524) from the list of icons currently displayed. This change occurs in response to two link components being removed from the smart wristband. The smart watch system detects these changes and updates the displayed icons to match the current capabilities of the various link components. For example, a user realizes that his battery charge is being quickly depleted. As a result, he removes a link component with a depleted battery to charge it and removes a heartbeat monitor which is not currently needed and will result in less energy used. The icons on the watch face are updated to reflect these changes.

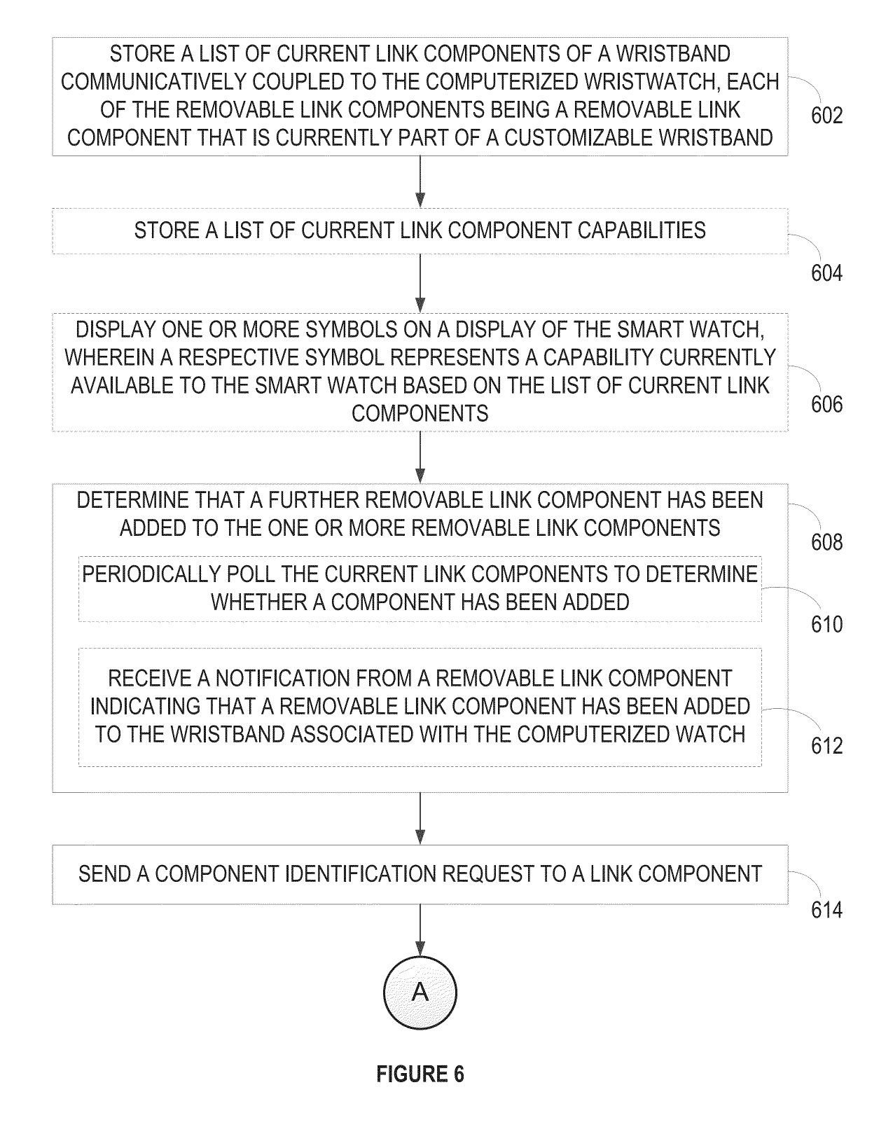

FIG. 6 is a flow diagram illustrating a process for enabling removable link components in a smart watch system in accordance with some implementations. Each of the operations shown in FIG. 6 may correspond to instructions stored in a computer memory or computer readable storage medium. Optional operations are indicated by dashed lines (e.g., boxes with dashed-line borders). In some implementations, the method described in FIG. 6 is performed by the central component (e.g., component 102 as seen in FIG. 1).

In some implementations, the method is performed at a central component (e.g., component 102 as seen in FIG. 1) that includes one or more processors, one or more removable link components in a customizable wristband, and memory storing one or more programs for execution by the one or more processors. In some implementations, the wristband is entirely composed of removable link components that connect to each other and to the central component (e.g., component 102 as seen in FIG. 1). In other implementations, the wristband includes a framework or scaffolding into which the removable link components are inserted.

The central component (e.g., component 102 as seen in FIG. 1) stores (602) a list of current link components, wherein each removable link component in the list of current link components represents a removable link component currently part of a customizable wristband attached to the central component (e.g., component 102 as seen in FIG. 1) of smart watch system. For example, if there are currently three link components (an extra battery, a GPS sensor, and a heart rate monitor), the list of current link components would include a list of all three components.

The central component (e.g., component 102 as seen in FIG. 1) also stores (604) a list of current link component capabilities. This list is based on the link components currently attached to the central component (e.g., component 102 as seen in FIG. 1). The central component (e.g., component 102 as seen in FIG. 1) determines, for each link component in the list of current link components, what capabilities are provided by that component. For example, a fitness tracker link component includes a step counter capability and a heartbeat monitor capability. Both capabilities are added to a list of currently available capabilities.

In some implementations, the central component (e.g., component 102 as seen in FIG. 1) determines capabilities associated with various link components by requesting identifying information from the component. The central component (e.g., component 102 as seen in FIG. 1) then uses the identifying information (e.g., a component ID number) to identify capabilities associated with the link component. For example, the central component (e.g., component 102 as seen in FIG. 1) stores a list of potential link components and the associated capabilities. In other examples, the central component (e.g., component 102 as seen in FIG. 1) connects to a third party server over a communication network to determine the associated capabilities. In another example, each link component transmits a list of its capabilities to the central component (e.g., component 102 as seen in FIG. 1) when the link is initially connected.

In some implementations, the central component (e.g., component 102 as seen in FIG. 1) displays (606) one or more symbols on a display of the smart watch system (e.g., symbols 516-524 of FIGS. 5A-5D), wherein a symbol represents a capability currently available to the smart watch system based on the list of current link components. For example, the display of the central component (e.g., component 102 as seen in FIG. 1) shows an icon that represents a step count as long as a step count link component is connected to the central component (e.g., component 102 as seen in FIG. 1). In this way a user can easily determine what link components are currently attached to the central component (e.g., component 102 as seen in FIG. 1) as part of the smart wristband.

The central component (e.g., component 102 as seen in FIG. 1) determines (608) that a removable link component has been added to the one or more removable link components (e.g., added to a wristband of a smart watch). In some implementations, the central component (e.g., component 102 as seen in FIG. 1) determines that a link component has been added by periodically polling (610) the current link components to determine whether a component has been added. For example, the central component (e.g., central component 102 as seen in FIG. 1) sends out a component identification request every 10 seconds. The request is propagated around the wristband such that each current component receives it. In response, each component responds to the component identification request by transmitting link component identification information (e.g., a link component ID, name or list of capabilities).

The central component (e.g., component 102 as seen in FIG. 1) then compares all the received component identification information against the list of current link components to determine if any of the identified components are not currently on the list of current link components (e.g., a new link that has been added).

In some implementations, the central component (e.g., component 102 as seen in FIG. 1) receives (612) a notification from a removable link component (e.g., one that has been added) indicating that a removable link component has been added to the wristband associated with the smart watch system. For example, each link when connected to the wristband automatically sends out a notification. The notification includes identification information for the link component (e.g., component ID or component name) and indicates that the component is being added (rather than being removed).

The central component (e.g., component 102 as seen in FIG. 1) then sends (614) a component identification request to the link component (the recently added link component). As noted above, a component identification request is a request that prompts a link component (the recently added link component) to respond with identification information regarding its capabilities and its identity.

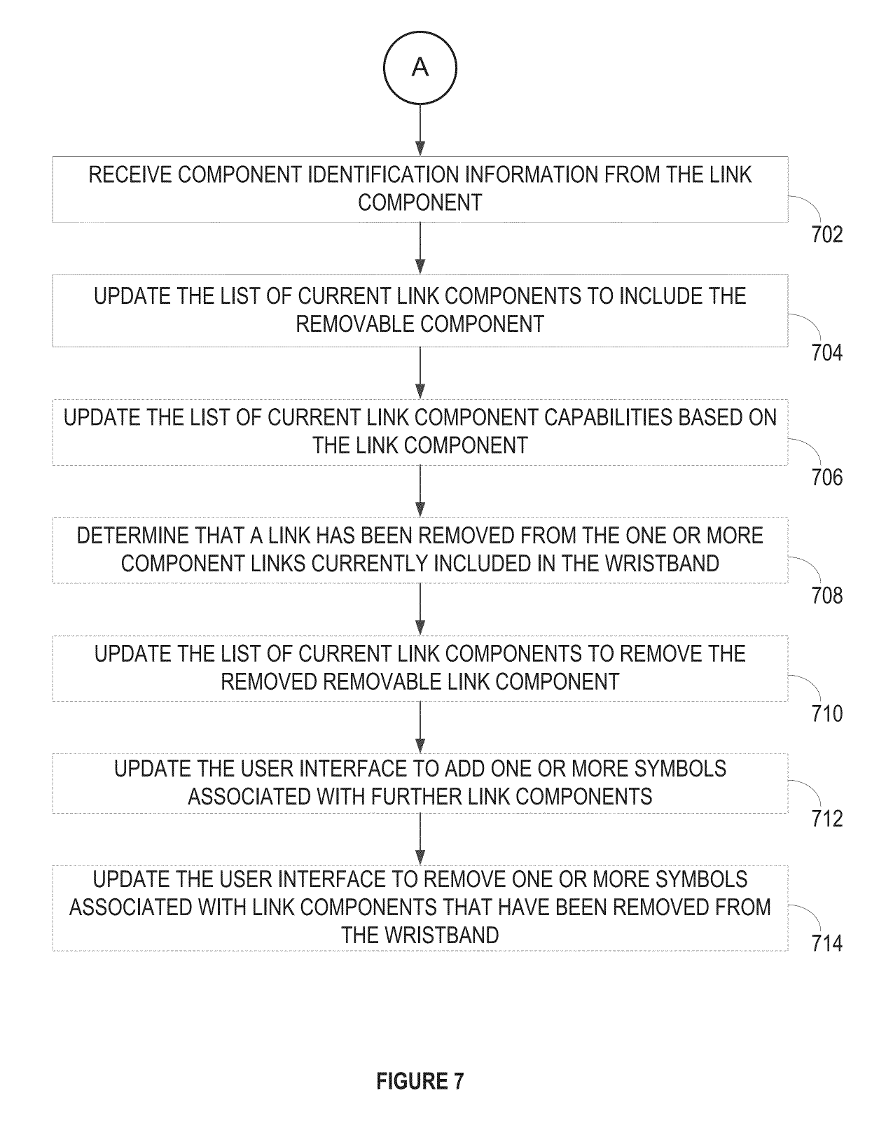

FIG. 7 is a flow diagram illustrating a process for enabling removable link components in a smart watch system in accordance with some implementations. FIG. 7 represents a continuation of the process displayed in FIG. 6. Each of the operations shown in FIG. 7 may correspond to instructions stored in a computer memory or computer readable storage medium. Optional operations are indicated by dashed lines (e.g., boxes with dashed-line borders). In some implementations, the method described in FIG. 7 is performed by the central component (e.g., component 102 in FIG. 1).

In some implementations, the method is performed at a smart watch system that includes one or more processors, one or more removable link components, and memory storing one or more programs for execution by the one or more processors.

The central component (e.g., component 102 as seen in FIG. 1) receives (702) component identification information from the link component (the recently added link component). In some implementations, the component identification information identifies the capabilities of the link component with which it is associated. The central component (e.g., component 102 as seen in FIG. 1) then updates (704) the list of current link components to include the link component (the recently added link component). In some implementations, the central component (e.g., component 102 as seen in FIG. 1) then updates (706) the list of current link component capabilities based on the link component (the recently added link component).

In some implementations, the central component (e.g., component 102 as seen in FIG. 1) determines (708) that a link has been removed from the one or more component links currently included in the wristband. As noted above, this can be accomplished in several ways, including, but not limited to, periodic polling and automatic notifications from the link component when it is removed.

The central component (e.g., component 102 as seen in FIG. 1) then updates (710) the list of current component links to remove the link component that has been removed from the smart wristband. For example, if a user removes the link component that provides a Wi-Fi connection, the central component (e.g., component 102 as seen in FIG. 1) then removes the Wi-Fi link component from the list of current link components.

After the list of current link components has been updated, the central component (e.g., component 102 as seen in FIG. 1) updates (712) the user interface to add one or more symbols associated with link components (the recently added link component). For example, as seen in FIG. 5B, the list of symbols is updated to add components that have been added (e.g., heartbeat monitor symbol 524 in FIG. 5B). In some implementations, after the list of current link components has been updated, the central component (e.g., component 102 as seen in FIG. 1) updates (714) the user interface to remove one or more symbols associated with link components that have been removed from the smart wristband.

In some implementations, link components are added from a list that includes, but is not limited to, an additional memory capacity component, an additional battery capacity component, an additional processing capacity component, a step counter, a fitness tracker, a GPS tracker, a compass component, a blood glucose monitor, a camera component, a voice recording component, an RFID tag component, a Bluetooth component, a proximity sensor component, an infrared sensor component, a remote control component, an environment measuring component, a camera, an audio recording device, a touch input device, or a wireless communication component.

### Software Architecture

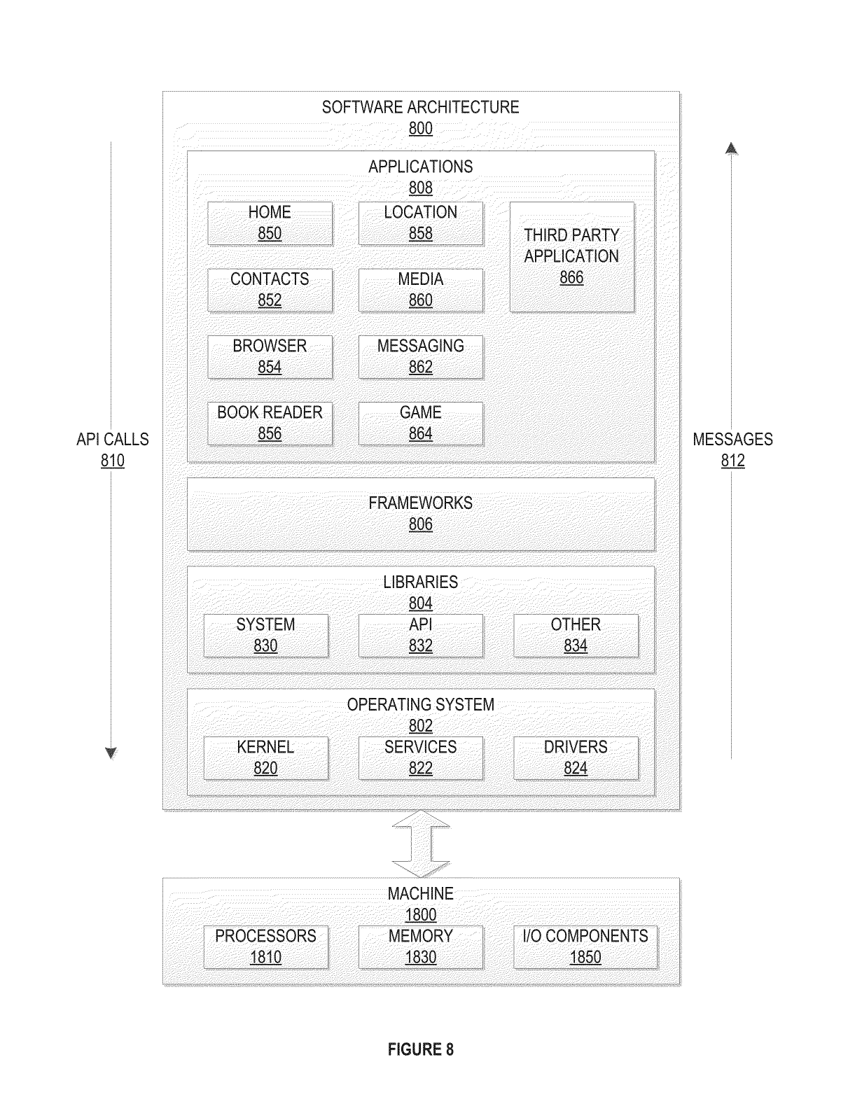

FIG. 8 is a block diagram illustrating an architecture of software 800, which may be installed on any one or more of devices of FIG. 1 (e.g., client device(s) 110). FIG. 8 is merely a non-limiting example of a software architecture and it will be appreciated that many other architectures may be implemented to facilitate the functionality described herein. The software 800 may be executing on hardware such as machine 1800 of FIG. 18 that includes processors 1810, memory 1830, and I/O components 1850. In the example architecture of FIG. 8, the software 800 may be conceptualized as a stack of layers where each layer may provide particular functionality. For example, the software 800 may include layers such as an operating system 802, libraries 804, frameworks 806, and applications 808. Operationally, the applications 808 may invoke application programming interface (API) calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 808. The libraries 804 may include system libraries (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 808.

The frameworks 806 may provide a high-level common infrastructure that may be utilized by the applications 808. For example, the frameworks 806 may provide various graphic user interface (GUI) functions, high-level resource management, high-level location services, and so forth. The frameworks 806 may provide a broad spectrum of other APIs that may be utilized by the applications 808, some of which may be specific to a particular operating system or platform.

The applications 808 include a home application 850, a contacts application 852, a browser application 854, a book reader application 856, a location application 858, a media application 860, a messaging application 862, a game application 864, and a broad assortment of other applications such as third party application 866. In a specific example, the third party application 866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 866 may invoke the API calls 810 provided by the mobile operating system 802 to facilitate functionality described herein.

### Example Machine Architecture and Machine-Readable Medium

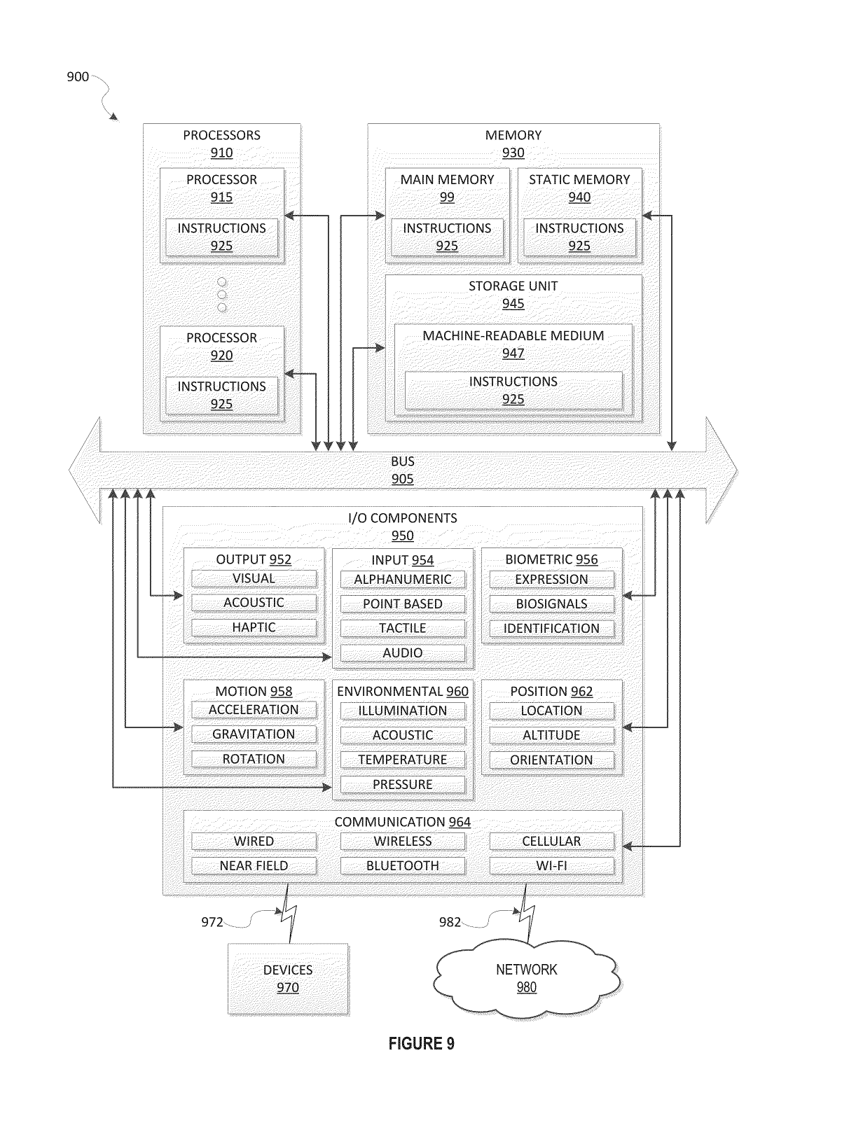

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 915 and processor 920 that may execute instructions 925. The term “processor” is intended to include multi-core processor that may comprise two or more independent processors (also referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory 930 may include a main memory 935, a static memory 940, and a storage unit 945 accessible to the processors 910 via the bus 905. The storage unit 945 may include a machine-readable medium 947 on which is stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, static memory 940, and the processors 910 may be considered as machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown in an example embodiment to be a single medium, the term “machine-readable medium” should be taken to include a single medium or multiple media (e.g., a centralized or distributed database, or associated caches and servers) able to store instructions 925. The term “machine-readable medium” shall also be taken to include any medium, or combination of multiple media, that is capable of storing instructions (e.g., instructions 925) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the !/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 950 may include biometric components 956, motion components 958, environmental components 960, and/or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine and/or any of a wide variety of peripheral devices (e.g., a peripheral device couple via a Universal Serial Bus (USB)).

Moreover, the communication components 964 may detect identifiers and/or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 964 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks. Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 925 may be transmitted and/or received using a transmission medium via the coupling 972 (e.g., a peer-to-peer coupling) to devices 970. The term “transmission medium” shall be taken to include any intangible medium that is capable of storing, encoding, or carrying instructions 925 for execution by the machine 900, and includes digital or analog communications signals or other intangible medium to facilitate communication of such software.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A wearable computer system comprising one or more processors, memory, and an attachment accessory that includes one or more removable link components, the attachment accessory operatively to secure the system to the person of a user, the wearable computer system being configured such that the removable link components can be added to or removed from the attachment band and the capabilities of the wearable computer system change as components are added or removed.

2. A computerized wristwatch comprising:
one or more processors;
memory; and
one or more programs stored in the memory, the one or more programs comprising instructions for:
storing a list of current link components of a wristband communicatively coupled to the computerized wristwatch, each of the removable link components being a removable link component that is currently part of a customizable wristband;
determining that a further removable link component has been added to the customizable wristband;
sending a component identification request to the further removable link component;
receiving component identification information from the further removable link component; and
updating the list of current link components to include the further removable link component.

3. The system of claim 2 further including one or more removable link components in the configurable wristband.

4. The system of claim 2, wherein the instructions for determining that a further removable link component has been added to the customizable wristband further include instructions for:
periodically polling removable link components in the list of current link components to determine whether a further removable link component has been added to the wristband.

5. The system of claim 2, wherein the instructions for determining that a further removable link component has been added further include instructions for:
receiving a notification from a removable link component indicating that a further removable link component has been added to the wristband associated with the computerized wristwatch.

6. The system of claim 2, further including instructions for:
determining that a removable link component has been removed from the one or more removable link components currently included in the wristband; and
updating the list of current link components to remove the removable link component that has been removed from the customizable wristband.

7. The system of claim 3, wherein each of the one or more removable link components has one or more associated capabilities.

8. The system of claim 2, further including instructions for storing a list of current link component capabilities.

9. The system of claim 8, further including instructions for updating the list of current link component capabilities based on any further link components.

10. The system of claim 2, further including displaying one or more symbols on a user interface of the computerized wristwatch, wherein a symbol represents a capability currently available to the smart watch based on the list of current link components.

11. The system of claim 10, wherein, after the list of current link components has been updated, updating the user interface to add one or more symbols associated with added removable link components.

12. The system of claim 8, wherein the component identification information identifies the capabilities of the removable link component with which it is associated.

13. The system of claim 10, wherein, after the list of current link components has been updated, updating the user interface to reflect the changes to the list of current link components.

14. The system of claim 2, wherein a removable link component is from a list including an additional memory capacity component, an additional battery capacity component, an additional processing capacity component, a step counter, a fitness tracker, a GPS tracker, a compass component, a blood glucose monitor, a camera component, a voice recording component, an RFID tag component, a Bluetooth component, a proximity sensor component, an infrared sensor, a remote control component, an environment measuring component, or a wireless communication component.

15. A method comprising:
storing a list of current link components of a wristband communicatively coupled to the computerized wristwatch, each of the removable link components being a removable link component that is currently part of a customizable wristband;
determining, by a central component with one or more processors, that a further removable link component has been added to the customizable wristband;
sending a component identification request to the further removable link component;
receiving component identification information from the further removable link component; and
updating the list of current link components to include the further removable link component.

16. The method of claim 15 further including one or more removable link components in the configurable wristband.

17. The method of claim 15, wherein the instructions for determining that a further removable link component has been added to the customizable wristband further include instructions for:
periodically polling removable link components in the list of current link components to determine whether a further removable link component has been added to the wristband.

18. The method of claim 15, wherein the instructions for determining that a further removable link component has been added further include instructions for:
receiving a notification from a removable link component indicating that a further removable link component has been added to the wristband associated with the computerized wristwatch.

19. The method of claim 16, wherein each of the one or more removable link components has one or more associated capabilities.

20. The method of claim 15, including displaying one or more symbols on a user interface of the computerized wristwatch, wherein a symbol represents a capability currently available to the smart watch based on the list of current link components.
